(19) United States
(12) Patent Application Publication
(10) Pub. No.: US 2013/0312299 A1
(43) Pub. Date: Nov. 28, 2013

(54) BILLBOARD CAPABLE OF AUTOMATICALLY CHANGING DISPLAY CONTENTS

(71) Applicant: Cheng-Chen CHEN, New Taipei City (TW)

(72) Inventor: Cheng-Chen CHEN, New Taipei City (TW)

(21) Appl. No.: 13/481,367

(22) Filed: May 25, 2012

(51) Int. Cl. G09F 13/00

(52) U.S. Cl. 40/541

(57) ABSTRACT

A billboard capable of automatically changing display contents includes a board base, and a plurality of light emitting units flexibly arranged on the board base. The board base includes a plurality of slots formed on a surface of the board base, and two conductive spring plates installed in the slots. Each light emitting unit includes an insert portion, a light emitting portion disposed above the insert portion, and two conducting terminals contained in the insert portion, and the insert portion of each light emitting unit is pluggable into each slot for respectively and electrically connecting the conducting terminals to the conductive spring plates, such that each light emitting unit is pluggable into each slot to flexibly select each desired slot to be plugged in order to flexibly change the display contents by users.

### FIELD OF THE INVENTION

The present invention relates to a display panel, in particular to a billboard capable of automatically changing display contents.

### BACKGROUND OF THE INVENTION

In conventional billboards or display devices with a light source of light emitting diodes (LEDs), the light emitting diodes are generally installed or mounted on a circuit board, and a program is provided for controlling the ON and OFF states of each light emitting diode in order to change the display contents. The displayed contents of the billboards or display devices of this sort are limited to factory default settings of the products, unless the program is modified to add other desired display contents.

However, more functions of billboards or display devices are required for diversity of applications used in different occasions nowadays, so that the billboards or display devices usually have a need of changing the display contents according to the applications frequently, or else it is necessary to prepare different billboards or display devices for different occasions. Obviously, such design is inconvenient.

In view of the foregoing problems of the prior art, the inventor of the present invention conducted extensive researches and experiments, and finally provided a feasible design to overcome the problems.

### SUMMARY OF THE INVENTION

Therefore, it is a primary objective of the present invention to provide a billboard capable of automatically changing display contents, wherein a design of pluggable light emitting units is provided to allow users to flexibly arrange the light emitting units on the billboard according to the user requirements in order to display a desired content, and a single billboard can be used to display different display contents for different occasions.

To achieve the foregoing objective, the present invention provides a billboard capable of automatically changing display contents, comprising: a board base, and a plurality of light emitting units flexibly arranged on the board base by a user; wherein the board base includes a plurality of slots formed on a surface of the board base, two conductive spring plates installed in each slot, and each light emitting unit includes an insert portion, a light emitting portion disposed above the insert portion, and two conducting terminals contained in the insert portion, and each light emitting unit of the insert portion is pluggable into each slot for respectively and electrically connecting the two conducting terminals of each light emitting unit with the two conductive spring plates of the board base, such that each light emitting unit is pluggable into each slot to flexibly select a desired slot to be plugged, in order to change the display contents flexibly by users.

### BRIEF DESCRIPTION OF THE DRAWINGS

FIG. 1 is an exploded view of the present invention;

FIG. 2 is a close-up view of a light emitting unit of the present invention;

FIG. 3 is a cross-sectional view of a light emitting unit of the present invention;

FIG. 4 is a perspective view of the present invention;

FIG. 5 is a cross-sectional view of Section 5-5 of FIG. 3;

FIG. 6 is a cross-sectional view of Section 6-6 of FIG. 3; and

FIG. 7 is a schematic view of an application of the present invention.

### DESCRIPTION OF THE PREFERRED EMBODIMENTS

The details and technical contents of the present invention will become apparent with the description of the following preferred embodiments accompanied with the illustration of the related drawings as follows. However, the drawings are provided for reference and for the purpose of illustrating the present invention only, but not intended for limiting the scope of the invention.

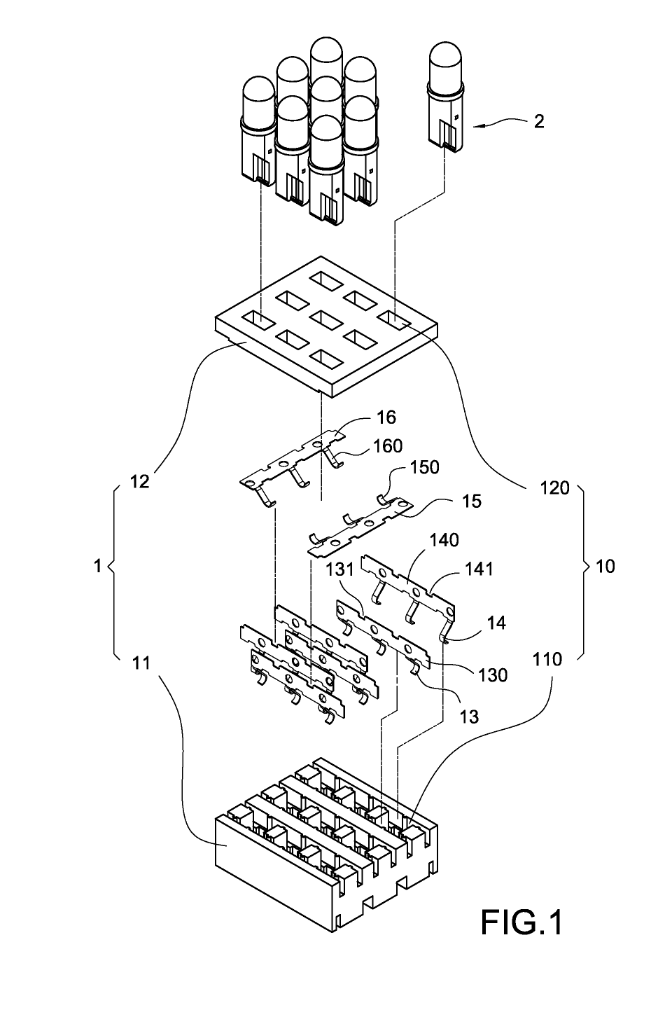

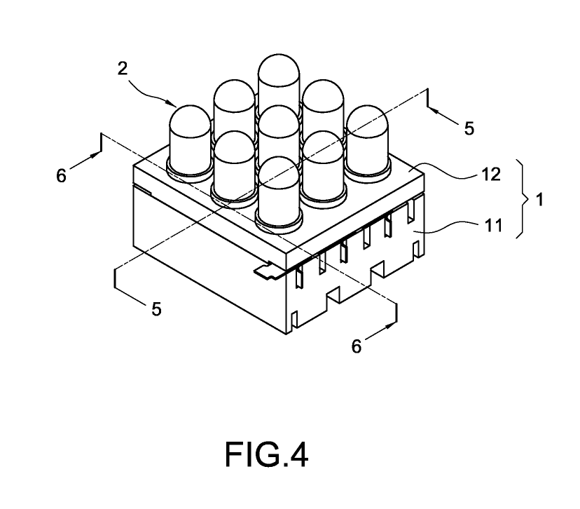

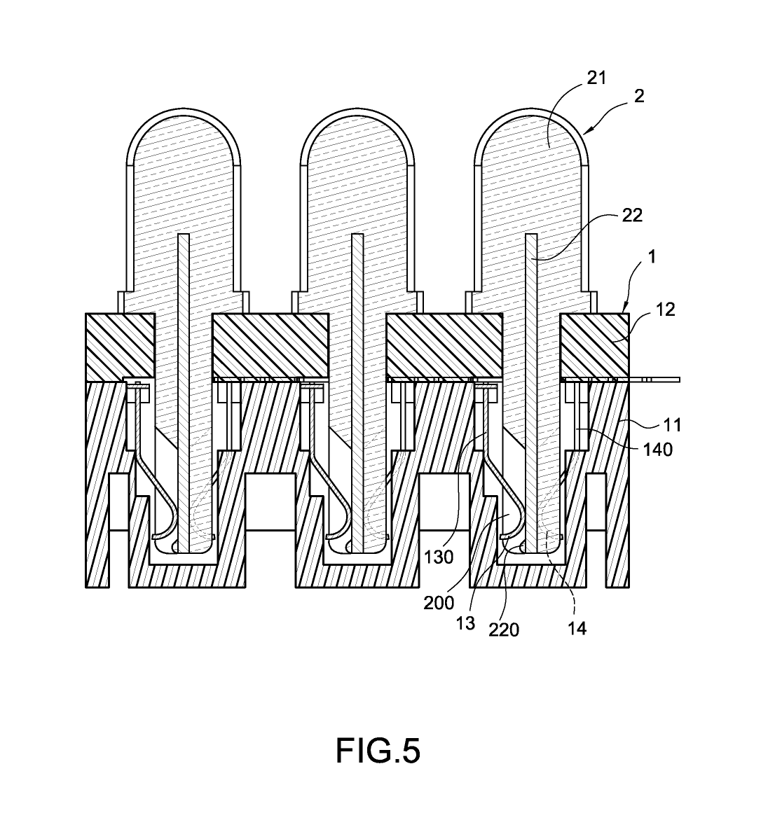

With reference to FIGS. 1 and 4 for an exploded view and a perspective view of the present invention respectively, the present invention provides a billboard capable of automatically changing display contents, comprising: a board base 1, and a plurality of light emitting units 2 flexibly arranged on the board base 1 by a user.

The board base 1 is substantially a board having a plurality of slots 10 formed on a surface of the board base 1, and the slots 10 are generally arranged in an array such as a matrix on a surface of the board base 1, such that after each light emitting unit 2 is inserted and electrically coupled to each respective slot 10, each light emitting unit 2 is arranged into a pattern to display the desired display contents including texts or graphics on the board base 1. In a preferred embodiment of the present invention, the board base 1 includes a seat 11 and a front panel 12 covered onto the seat 11, and the slot 10 has a containing area 110 defined on the seat 11 and a through hole 120 formed on the front panel 12.

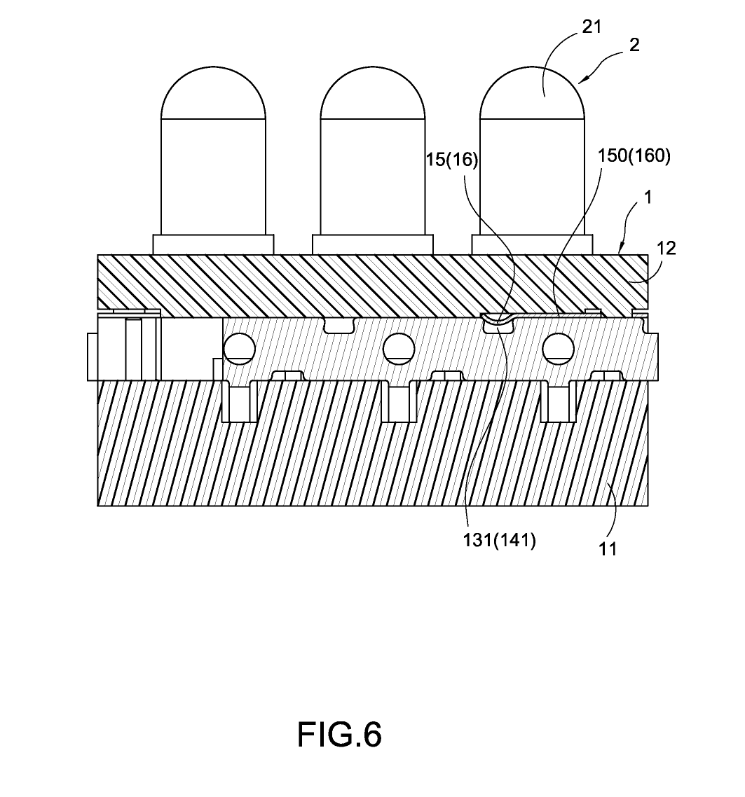

More specifically, each slot 10 includes two conductive spring plates 13, 14 installed therein for electrically connecting positive and negative electrodes of each of the light emitting units 2. In a preferred embodiment of the invention, the slots 10 are arranged in a matrix, and one of the conductive spring plates 13 (such as the positive electrode) of each slot 10 in the same row (or the same column) is disposed at an edge of a first connecting conductive plate 130, and the other conductive spring plate 14 (such as the negative electrode) is disposed at an edge of a second connecting conductive plate 140 to facilitate the electric connection and integration of the two conductive spring plates 13, 14 in each slot 10. Based on the preferred embodiment of the invention, the following is further disclosed. The first connecting conductive plate 130 in each row (or each column) is conductively connected to a first electrode plate 15, and the second connecting conductive plate 140 in each row (or each column) is conductively connected to a second electrode plate 16, so that after the positive and negative electrode of an electric power supply are connected to the first and second electrode plates 15, 16 respectively, the light emitting units 2 can be plugged into the corresponding slots 10 to obtain electric power. In addition, the first and second electrode plates 15, 16 can be conductively connected to the first and second connecting conductive plates 130, 140 as required, and the quantity of conducting plates 150, 160 can be changed according to the actual requirements, and each of the first and second connecting conductive plates 130, 140 has a corresponding notch 131, 141 formed at an upper edge of each of the first and second connecting conductive plates 130, 140 and provided for the conducting plate 150, 160 to touch and press against the notch 131, 141 as shown in FIG. 6.

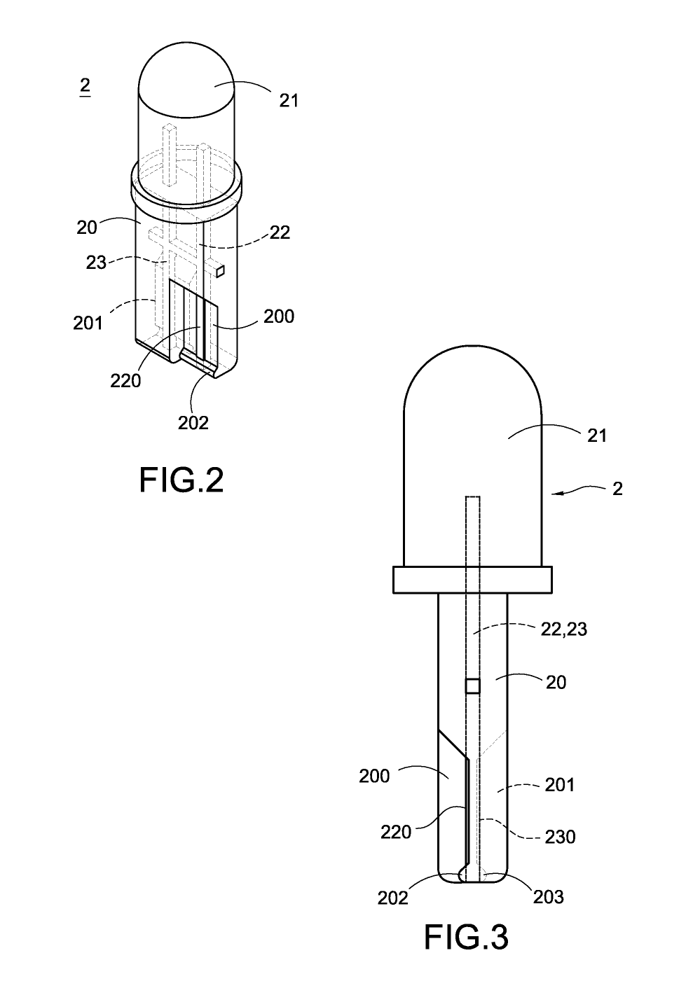

With reference to FIGS. 2 and 3, the light emitting units 2 can be light emitting diodes (LEDs) that receive electric power by electrically connecting to the board base 1 in order to generate a light source, and a program is used to achieve the effect of displaying the contents in different colors or with blinking. Each light emitting unit 2 includes an insert portion 20, a light emitting portion 21 disposed above the insert portion 20, and two conducting terminals 22, 23 contained in the insert portion 20. The insert portion 20 is made of an insulating material and can be plugged precisely into each slot 10 of the board base 1 and provided for protruding the light emitting portion 21 out of the slot 10 to expose the light source. Each light emitting unit 2 is electrically coupled to the board base 1 through the two conducting terminals 22, 23, and each of the two conducting terminals 22, 23 of the light emitting unit 2 has a contact portion 220, 230 exposed from the insert portion 20 and provided for inserting the light emitting unit 2 into the slot 10 for an electric connection.

More specifically, each light emitting unit 2 includes two concave openings 200, 201 concavely formed at a lower end of the insert portion 20, and the contact portions 220, 230 of the two conducting terminals 22, 23 are exposed from the two concave openings 200, 201 respectively. In this preferred embodiment of the present invention, the two concave openings 200, 201 are formed on two opposite sides of the insert portion 20 respectively and arranged alternately with each other, so that the two conductive spring plates 13, 14 in each slot 10 abut each other at the two concave openings 200, 201 to facilitate the insertion of the light emitting units 2 into the slots 10 to achieve a clamping effect. In FIG. 5, when the light emitting units 2 are inserted into the corresponding slots 10 respectively, the two conductive spring plates 13, 14 in each slot 10 will abut the contact portions 220, 230 at ends of the two conducting terminals 22, 23 of the light emitting unit 2 accordingly. Further, a flange 202, 203 is formed at the ends of the two concave openings 200, 201 of each light emitting unit 2 separately to provide an external force required for unplugging the light emitting unit 2 from the slot 10 easily.

With the aforementioned assembly, the billboard capable of automatically changing display contents in accordance with the present invention is achieved.

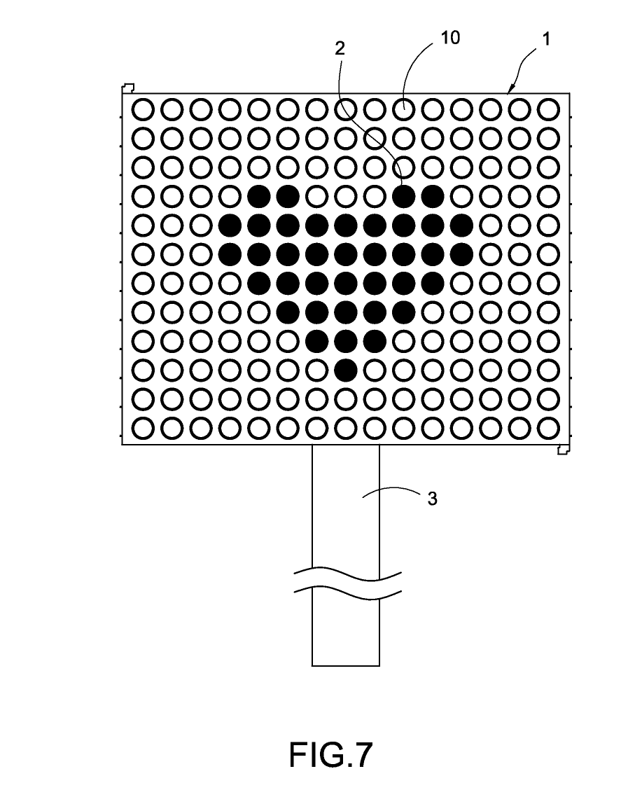

In FIG. 7, the pluggable design of each light emitting unit 2 allows users to arrange the desired display contents on the board base 1 flexibly, so that a single billboard can be used to display different display contents for different occasions. It is noteworthy that a handle 3 can be installed at the bottom of the board base 1 to facilitate users to hold or erect the billboard.

In summation of the description above, the invention improves over the prior art and complies with the patent application requirements, and thus is duly filed for patent application. While the invention has been described by means of specific embodiments, numerous modifications and variations could be made thereto by those skilled in the art without departing from the scope and spirit of the invention set forth in the claims.

1. A billboard capable of automatically changing display contents, comprising:
a board base, including a plurality of slots, each slot having an opening formed on a surface of the board base, and two conductive spring plates installed in the slots; and
a plurality of light emitting units capable of being plugged into and unplugged out of the slots, respectively, each including an insert portion, a light emitting portion disposed above the insert portion, and two conducting terminals contained in the insert portion, and each light emitting portion protruding from and sitting on the surface when each insert portion being pluggable into each respective slot from each respective opening for electrically connecting the two conducting terminals of each light emitting unit to the two conductive spring plates of the board base;
thereby, each light emitting unit is pluggable into each slot for flexibly selecting each desired slot to be plugged to change the display contents by a user.

2. The billboard capable of automatically changing display contents as recited in claim 1, wherein the board base is substantially a board.

3. The billboard capable of automatically changing display contents as recited in claim 1, wherein the slots are arranged in an array on a surface of the board base.

4. The billboard capable of automatically changing display contents as recited in claim 3, wherein the array is a matrix.

5. The billboard capable of automatically changing display contents as recited in claim 1, wherein the board base includes a seat and a front panel covered onto the seat, and each slot has a containing area defined on the seat, and a through hole formed on the front panel.

6. The billboard capable of automatically changing display contents as recited in claim 1, wherein the board base includes a handle installed at the bottom of the board base.

7. The billboard capable of automatically changing display contents as recited in claim 1, wherein the light emitting units are light emitting diodes.

8. The billboard capable of automatically changing display contents as recited in claim 1, wherein each light emitting unit includes two concave openings concavely formed at a lower end of the insert portion, and a contact portion disposed at an end of the two conducting terminals of each light emitting unit, and exposed from the two concave openings.

9. The billboard capable of automatically changing display contents as recited in claim 8, wherein the two concave openings are formed on two opposite sides of the insert portion respectively and arranged alternately with each other.
